(19) United States
(12) Patent Application Publication
(10) Pub. No.: US 2003/0046164 A1
(43) Pub. Date: Mar. 6, 2003

(54) Method for providing content distribution service and terminal device

(76) Inventors: Junichi Sato, Nara (JP); Takao Yamaguchi, Machida (JP); Hiroshi Arakawa, Kyoto (JP); Tomoaki Itoh, Kawasaki (JP)

Correspondence Address: SNELL & WILMER, ONE ARIZONA CENTER, 400 EAST VAN BUREN, PHOENIX, AZ, 850040001

(21) Appl. No.: 10/197,088

(22) Filed: Jul. 16, 2002

(30) Foreign Application Priority Data
Jul. 16, 2001 (JP) 2001-215573

(51) Int. Cl. G06F 17/60

(52) U.S. Cl. 705/14

(57) ABSTRACT

A process, for providing a content distribution service using a terminal device including an acquisition section for acquiring a state of the terminal device and a processing device for transmitting data to the terminal device, includes the steps of the processing device acquiring content data representing a prescribed content; the processing device acquiring attribute data which specifies a condition regarding the state of the terminal device and a presentation form of the content corresponding to the condition; and the processing device transmitting the content data and the attribute data to the terminal device.

### BACKGROUND OF THE INVENTION

1. Field of the Invention

The present invention relates to a process for providing a content distribution service using a terminal device including an acquisition section for acquiring a state of the terminal device and a processing device for transmitting data to the terminal device, and a terminal device usable for such a content distribution service.

2. Description of the Related Art

A known system for appropriately switching the presentation form of a content to be distributed in accordance with a state of a terminal device is disclosed by Japanese Laid-Open Publication No. 2000-292182. According to the conventional technology disclosed in this publication, advertising information is transmitted to a terminal device mounted on a movable body such as, for example, an automobile. The terminal device which has received the advertising information appropriately switches the presentation form of the advertising information in accordance with the state of the terminal device (for example, whether the movable body having the terminal device mounted thereon is moving or stationary). Such a switching operation allows the advertisement information to be notified to the driver of the movable body safely, i.e., without disturbing the driver while driving.

A provider of a content, such as advertisement information or the like, often wishes to specify the format in which the terminal device presents the content in accordance with the content as well as the state of the terminal device. For example, when the content has a feature that the provider considers cannot be sufficiently conveyed in the form of a sound, the provider may wish to present this content additionally in at least the form of a still picture or a moving picture of lower quality having a number of frames “thinned” therefrom, even while the movable body having the terminal device mounted thereon is moving.

However, according to the above-described conventional technology, the form in which the terminal device presents a content, such as advertisement information or the like, is fixed for each state of the terminal device. The form cannot be changed so as to reflect the provider's intention (for example, in accordance with the content). According to the above-described conventional technology, the advertisement information is presented in the form of a sound when the movable body is moving, and in the form of a sound and an image when the movable body is stationary, regardless of the elements of the advertisement information.

### SUMMARY OF THE INVENTION

According to one aspect of the invention, a process for providing a content distribution service using a terminal device including an acquisition section for acquiring a state of the terminal device and a processing device for transmitting data to the terminal device is provided. The process includes the steps of the processing device acquiring content data representing a prescribed content; the processing device acquiring attribute data which specifies a condition regarding the state of the terminal device and a presentation form of the content corresponding to the condition; and the processing device transmitting the content data and the attribute data to the terminal device.

In one embodiment of the invention, the step of transmitting the content data and the attribute data includes the step of transmitting the content data and the attribute data as one packet.

In one embodiment of the invention, the attribute data specifies, as the condition regarding the state of the terminal device, at least one of a condition regarding a position of the terminal device, a condition regarding a time when the terminal device presents the content, a condition regarding a time zone in which the terminal device presents the content, a condition regarding whether or not there is a passenger in a movable body having the terminal device mounted thereon, a condition regarding a moving speed of the movable body, and a condition regarding a time period in which the moving speed is continuously equal to or lower than a prescribed value.

In one embodiment of the invention, when there is a passenger in the movable body, the attribute data further specifies at least one of a condition regarding a position of the passenger and a condition regarding a profile of the passenger. The condition regarding the position of the passenger is selected from the group consisting of front seat, rear seat, and front and rear seats. The condition regarding the profile of the passenger is at least one selected from the group consisting of sex, adult or child, age, interest, and preference.

In one embodiment of the invention, the attribute data specifies the presentation form of the content which changes in accordance with at least one of the position of the passenger and the profile of the passenger.

In one embodiment of the invention, the presentation form includes at least one of a form of presenting the content as a moving picture, a form of presenting the content as a still picture, and a form of presenting the content as a sound.

In one embodiment of the invention, the presentation form includes a form of presenting the content as a moving picture, and the attribute data specifies a number of frames per second of the moving picture.

In one embodiment of the invention, the presentation form includes a form of presenting the content as a sound, and the attribute data specifies a number of reproduction channels of the sound.

According to another aspect of the invention, a terminal device includes a data output section for outputting content data representing a prescribed content, and attribute data which specifies a condition regarding a state of the terminal device and a presentation form of the content corresponding to the condition; an acquisition section for acquiring the state of the terminal device; a determination section for determining whether or not the state acquired by the acquisition section fulfills the condition; and at least one presentation section for, when the state acquired by the acquisition section is determined to fulfill the condition, presenting the content in a presentation form of the content corresponding to the condition.

In one embodiment of the invention, the data output section receives the content data and the attribute data from outside the terminal device, and outputs the content data and the attribute data to the determination section.

In one embodiment of the invention, the data output section reproduces the content data and the attribute data stored on an information recording medium and outputs the reproduced content data and attribute data to the determination section.

In one embodiment of the invention, the terminal device includes a first presentation section and a second presentation section. The attribute data specifies at least either a first condition regarding the state of the terminal device and a first presentation form of the content corresponding to the first condition, or a second condition regarding the state of the terminal device and a second presentation form of the content corresponding to the second condition. The determination section determines whether the state acquired by the acquisition section fulfills the first condition or the second condition. When the determination section determines that the state acquired by the acquisition section fulfills the first condition, the first presentation section presents the content in the first presentation form. When the determination section determines that the state acquired by the acquisition section fulfills the second condition, the second presentation section presents the content in the second presentation form.

In one embodiment of the invention, the terminal device includes a first presentation section and a second presentation section. The acquisition section further acquires presentation site specification information which is associated with the state acquired by the acquisition section and specifies at least one of the first presentation section and the second presentation section as a presentation site of the content. When the determination section determines that the state acquired by the acquisition section fulfills the condition, at least one of the first presentation section and the second presentation section which is specified by the presentation site specification information presents the content.

In one embodiment of the invention, the attribute data specifies, as the condition regarding the state of the terminal device, at least one of a condition regarding a position of the terminal device, a condition regarding a time when the terminal device presents the content, a condition regarding a time zone in which the terminal device presents the content, a condition regarding whether or not there is a passenger in a movable body having the terminal device mounted thereon, a condition regarding a moving speed of the movable body, and a condition regarding a time period in which the moving speed is continuously equal to or lower than a prescribed value.

In one embodiment of the invention, when there is a passenger in the movable body, the attribute data further specifies at least one of a condition regarding a position of the passenger and a condition regarding a profile of the passenger. The condition regarding the position of the passenger is selected from the group consisting of front seat, rear seat, and front and rear seats, The condition regarding the profile of the passenger is at least one selected from the group consisting of sex, adult or child, age, interest, and preference.

In one embodiment of the invention, the attribute data specifies the presentation form of the content which changes in accordance with at least one of the position of the passenger and the profile of the passenger.

In one embodiment of the invention, the presentation form includes at least one of a form of presenting the content as a moving picture, a form of presenting the content as a still picture, and a form of presenting the content as a sound.

In one embodiment of the invention, the presentation form includes a form of presenting the content as a moving picture, and the attribute data specifies a number of frames per second of the moving picture.

In one embodiment of the invention, the presentation form includes a form of presenting the content as a sound, and the attribute data specifies a number of reproduction channels of the sound.

Thus, the invention described herein makes possible the advantages of providing a process for providing a content distribution service for allowing the form in which the terminal device presents the content to reflect the provider's intention, and a terminal device usable for such a content distribution service.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram illustrating a structure of a content distribution service system 1 according to the present invention;

FIG. 2 shows an exemplary structure of distribution data 251;

FIG. 3 is a flowchart illustrating a procedure by which the service center 201 executes content distribution processing;

FIG. 4 shows an example of the distribution data 251 described in the XML format;

FIG. 5 shows another example of the distribution data 251 described in the XML format;

FIG. 6 shows an example of attribute data 252 described in the XML format;

FIG. 7 shows still another example of the distribution data 251 described in the XML format;

FIG. 8 shows a specific example of a process for providing a content distribution service according to the present invention;

FIG. 9A shows a picture 9001 presented on a first presentation section 104 of a terminal device 100;

FIG. 9B shows a picture 9002 presented on a second presentation section 1101 of the terminal device 100;

FIG. 9C shows another picture 9003 presented on the first presentation section 104 of the terminal device 100;

FIG. 9D shows still another picture 9004 presented on the first presentation section 104 of the terminal device 100;

FIG. 10 shows a structure of the distribution data 251 shown in FIG. 8;

FIG. 11 shows another structure of the distribution data 251 shown in FIG. 8:

FIG. 12 shows another specific example of a process for providing a content distribution service according to the present invention;

FIG. 13A shows a still picture 951a presented on a presentation section 104 of a terminal device 100:

FIG. 13B shows a still picture 951b presented on the presentation section 104 of the terminal device 100; and

FIG. 14 shows a structure of attribute data 252 shown in FIG. 12.

### DESCRIPTION OF THE PREFERRED EMBODIMENTS

Hereinafter, the present invention will be described by way of illustrative examples with reference to the accompanying drawings.

1. Overview of the Present Invention

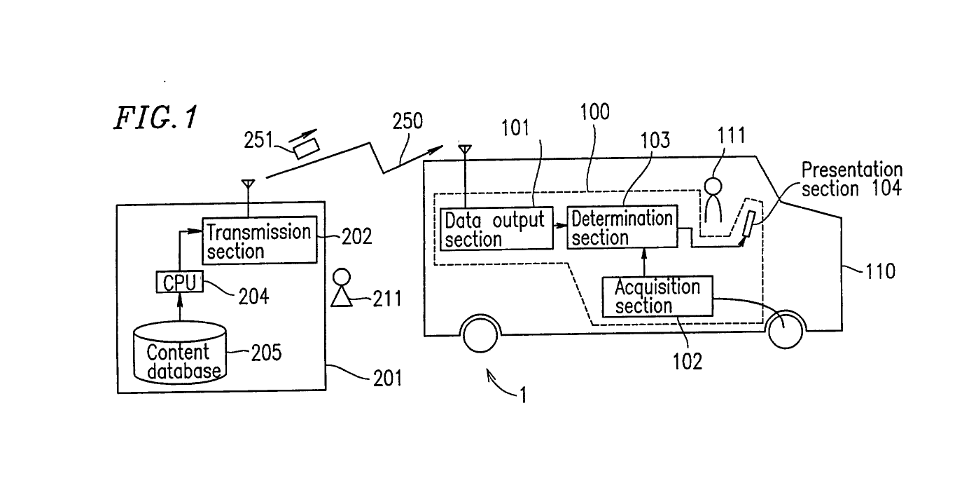

FIG. 1 shows a structure of a content distribution service system 1 according to the present invention.

The content distribution service system 1 includes a service center 201 and a terminal device 100. The service center 201 and the terminal device 100 are connected to each other via a communication path 250.

The terminal device 100 is mounted on a movable body 110. The movable body 110 is typically an automobile.

The communication path 250 can include any network such as, for example, various types of LANs including wireless LANs, WANs, telephone lines, and wireless telephone lines. In consideration that the terminal device 100 is mounted on the movable body 110, the communication path 250 preferably includes a wireless network. In the wireless network, an electromagnetic wave or an infrared ray is used as a medium for transferring information.

The service center 201 includes a content database 205, a CPU 204, and a transmission section 202. The service center 201 transmits distribution data 251 to the terminal device 100 via the communication path 250. The service center 201 can be any processing device; for example, a server computer. The service center 201 is managed by, for example, a transmitting party 211 wishing to distribute a content. Herein, the term “transmitting party” is defined to mean a provider of the content distribution service, and may or may not be a creator of the content.

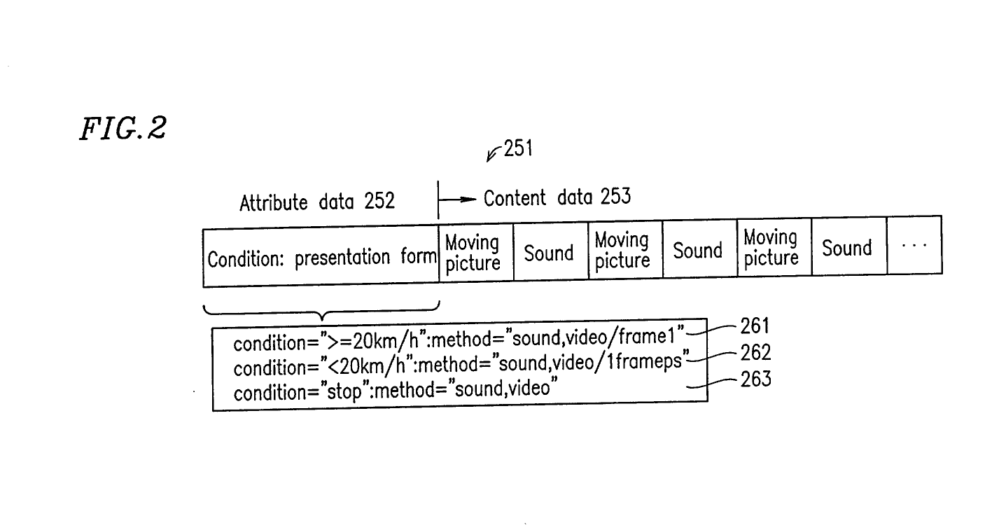

FIG. 2 shows an exemplary structure of the distribution data 251. The distribution data 251 includes attribute data 252 and content data 253. The distribution data 251 is, for example, in the form of a packet which includes the attribute data 252 in a packet header and the content data 253 in a data packet. The attribute data 252 specifies a condition regarding the state of the terminal device 100 (FIG. 1) and a presentation form of the content which corresponds to the condition. The content data 253 is data representing a prescribed content. In the example shown in FIG. 2, the content data 253 includes moving picture data and still picture data.

A row 261 specifies the condition:

“condition=”>=20 km/h”,

and the presentation form of the content which corresponds to the condition:

method=“sound,video/frame1”.

The row 261 indicates that when the state of the terminal device 100 fulfills the condition where the moving speed of the movable body 110 having the terminal device 100 mounted thereon is equal to or greater than 20 km/h, the terminal device 100 should present a content represented by the content data 253 in the form of presenting only a sound and the first frame (frame1) of a moving picture. In this case, the content is presented as a sound and a still picture.

Similarly, a row 262 indicates that when the state of the terminal device 100 fulfills the condition that the moving speed of the movable body 110 having the terminal device 100 mounted thereon is less than 20 km/h, the terminal device 100 should present the content in the form of a sound and a moving picture thinned to have one frame per second (i.e., in the state in which the quality is deteriorated). In this case, the content is presented as a sound and a quality-deteriorated moving picture.

A row 263 indicates that when the state of the terminal device 100 fulfills the condition that the movable body 110 having the terminal device 100 mounted thereon is stationary, the terminal device 100 should present the content in the form of a sound and a moving picture with no thinning (i.e., in the state in which the quality is not deteriorated). In this case, the content is presented as a sound and a moving picture with no quality deterioration.

In the example shown in FIG. 2, the attribute data 252 specifies the type of the media used for presenting the content (for example, a still picture, a moving picture, and/or a sound) and the quality of the media (for example, the number of frames per second of a moving picture) as the presentation form of the content which corresponds to the condition regarding the state of the terminal device 100 mounted on the movable body 110.

The type of the media may include, for example, a text (the form of presenting a content with a character string). As the quality of the media, the number of reproduction channels of a sound may be specified.

By specifying the type of the media used for presenting the content and the quality of the media as the presentation form of the content which corresponds to the condition regarding the state of the terminal device 100, the content can be presented in an optimum form corresponding to the state of the terminal device 100.

Assuming that, for example, the content data 253 includes still picture data, moving picture data and sound data, the content can be presented in the following manner. When the movable body 110 having the terminal device 100 mounted thereon is stationary, the moving picture data and the sound data are reproduced, so as to present the content in the form of the moving picture and the sound. When the movable body 110 is running at a low speed, the still picture data and the sound data are reproduced, so as to present the content in the form of the still picture and the sound. When the movable body 110 is running at a high speed, only the sound data is reproduced, so as to present the content in the form of the sound. Thus, the content can be presented to the driver 111 in an optimum form while allowing the driver 111 to keep on looking at the road and thus minimizing the risk of an accident.

In order to decrease the risk of the driver 111 causing an accident, it is also effective to reduce the number of reproduction channels of a sound (i.e., to lower the quality of the sound) while the movable body 110 is running at a high speed. The reason for this is because a stereo sound (a sound having two or more reproduction channels) has a higher possibility, than a monaural sound (a sound having one reproduction channel), of distracting the driver 111 from driving by a stereo sound effect.

In the example shown in FIG. 2, the attribute data 252 is described in a text format. Instead, the attribute data 252 may be described in a binary data format.

Returning to FIG. 1, an exemplary operation of the terminal device 100 which has received the distribution data 251 will be described.

The terminal device 100 includes a data output section 101 for receiving the distribution data 251 transmitted from the service center 201 and outputting the distribution data 251 to a determination section 103 described below, an acquisition section 102 for acquiring a state of the terminal device 100, the determination section 103, and a presentation section 104.

The data output section 101 may include a memory (not shown) for temporarily storing the distribution data 251 transmitted to the data output section 101.

In the example shown in FIG. 1, the acquisition section 102 acquires a moving speed of the movable body 110 having the terminal device 100 mounted thereon as the state of the terminal device 100. The moving speed of the movable body 110 can be acquired by, for example, measuring the number of rotations per unit time of a wheel of the movable body 110. By the acquisition section 102 acquiring the moving speed of the movable body 110, it can be determined whether the movable body 110 is running at a high speed or is stationary. It should be noted that the state of the terminal device 100 which can be acquired by the acquisition section 102 is not limited to the moving speed of the movable body 110.

The acquisition section 102 may acquire, for example, whether there is a passenger (an individual other than the driver 111) or not in the movable body 110. Information on whether there is a passenger or not in the movable body 110 can be acquired by, for example, providing a weight sensor, an infrared sensor, an image sensor or the like in or on a seat of the movable body 110.

The acquisition section 102 may alternatively acquire a time period in which the moving speed of the movable body 110 is continuously equal to or less than a prescribed value. When the time period, in which the moving speed of the movable body 110 is continuously equal to or less than the prescribed value, exceeds a prescribed value, the movable body 110 can be considered to be involved in a traffic jam.

In the case where the acquisition section 102 includes a GPS (Global Positioning System), the acquisition section 102 can detect the position of the terminal device 100. By detecting a time-wise change in the position of the terminal device 100, information on the moving direction of the movable body 110 having the terminal device 100 mounted thereon can be acquired. In the case where the acquisition section 102 has a watch function, information on the time at which the terminal device 100 presents the content can be acquired.

The determination section 103 determines whether or not the state of the terminal device 100 acquired by the acquisition section 102 fulfills a condition specified by the attribute data 252 included in the distribution data 251.

When the determination section 103 determines that the state of the terminal device 100 acquired by the acquisition section 102 fulfills the condition specified by the attribute data 252 included in the distribution data 251, the presentation section 104 presents the content in the presentation form specified by the attribute data 252 for the condition. The presentation section 104 includes, for example, a speaker for presenting the content in the form of a sound, and a display for presenting the content in the form of a still picture, a moving picture or a text.

The content distribution service is implemented by the service center 201 executing a procedure of transmitting the distribution data 251 to the terminal device 100 (a content distribution procedure).

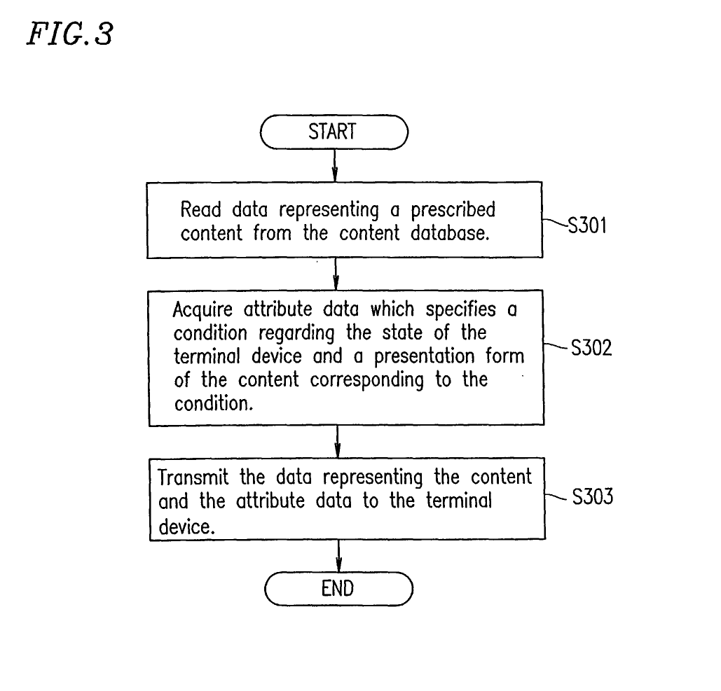

FIG. 3 shows a flow of an execution of the content distribution procedure by the service center 201. The content distribution procedure is performed by the CPU 204 (FIG. 1) executing a program for representing the content distribution procedure. This procedure is started by, for example, the transmitting party 211 (FIG. 1) wishing to distribute a content giving a prescribed command to the service center 201 (processing device).

Hereinafter, the flow of the content distribution procedure will be described in detail.

Step S301: The content data 253 representing a prescribed content is read from the content database 205. The content database 205 has the content data 253 accumulated in advance. The prescribed content is, for example, a content that the transmitting party 211 wishes to distribute. Such a content may be, for example, an advertisement, or a movie.

The acquisition of the content data 253 is not necessarily realized by reading the content data 253 from the content database 205. The content data 253 may be acquired by, for example, the service center 201 receiving the content data 253 from the creator of the content via any network.

Step S302: The attribute data 252 for specifying a condition regarding the state of the terminal device 100 to which the data (the attribute data 252 and the content data 253) is to be transmitted, and the presentation form of the content which corresponds to the condition, is acquired. The acquisition of the attribute data 252 may be realized, for example, by reading the attribute data 252 from the content database 205 together with the content data 253. Alternatively, the acquisition of the attribute data 252 may be realized by appropriately creating the attribute data 252 in correspondence with the content data 253 acquired in step S301.

As can be appreciated from the above, the CPU 204 (FIG. 1) of the service center 201 acts as an acquisition section for acquiring the content data 253 and the attribute data 252 in steps S301 and S302.

Step S303: The content data 253 acquired in step S301 and the attribute data 252 acquired in step S302 are transmitted to the terminal device 100. Such a transmission is realized, for example, as described above with reference to FIG. 2. Specifically, the transmission section 202 transmits the distribution section 251 to the terminal device 100 in the form of one packet including the attribute data 252 in a header portion and the content data 253 in a data packet portion.

As described above, according to the present invention, content data and attribute data are both transmitted to the terminal device 100. Therefore, the attribute data can be configured in compliance with the intention of the provider of the content distribution service (transmitting party of the content). For example, the attribute data can be created, depending on the content. As a result, the transmitting party's intention can be reflected in the form in which the terminal device presents the content in accordance with the state of the terminal device.

In the example described above with reference to FIGS. 1 and 3, the distribution data 251 is transmitted in one direction from the service center 201 (FIG. 1) to one terminal device 100 (FIG. 1). According to the present invention, the number of the terminal device 100 to which the distribution data 251 can be transmitted is not limited to one. The service center 201 may simultaneously transmit (broadcast) the distribution data 251 to an unspecified number of terminal devices 100. The form of transmitting the distribution data 251 in one direction from the service center 201 to one terminal device 100 (FIG. 1), and the form of broadcasting the distribution data 251 from the service center 201 to an unspecified number of terminal devices 100, are preferably used in the case where the communication path 250 is monodirectional.

In the case where the communication path 250 is bidirectional, the service center 201 may transmit the distribution data 251 in response to a request from the terminal device 100.

The present invention is not limited to transmitting the content data 253 and the attribute data 252 in one packet included in the distribution data 251. Instead, the content data 253 and the attribute data 252 may be separately transmitted and received by the terminal device 100 via different networks. For example, the terminal device 100 may receive the attribute data 252 via the Internet and then receive the content data 253 corresponding to the attribute data 252 via a wireless network.

The terminal device 100 may use a system of starting a presentation of the content after the entirety of the content data 253 is received (download system), or a system of starting a presentation of the content portion by portion while still receiving the rest of the content of the content data 253 (stream system). In either case, the attribute data 252, required for determining the presentation form, needs to be completely received before the presentation of the content is started.

The service center 201 and the terminal device 100 do not necessarily communicate each other via a packet. Any communication protocol is usable.

2. Examples of a Data Structure of Distribution Data

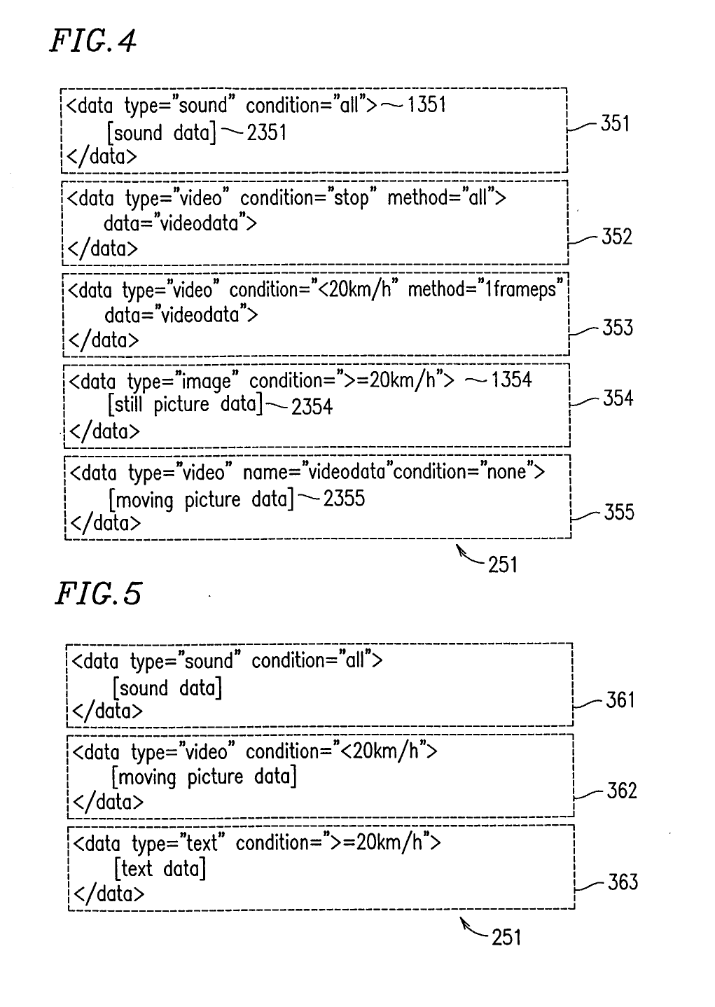

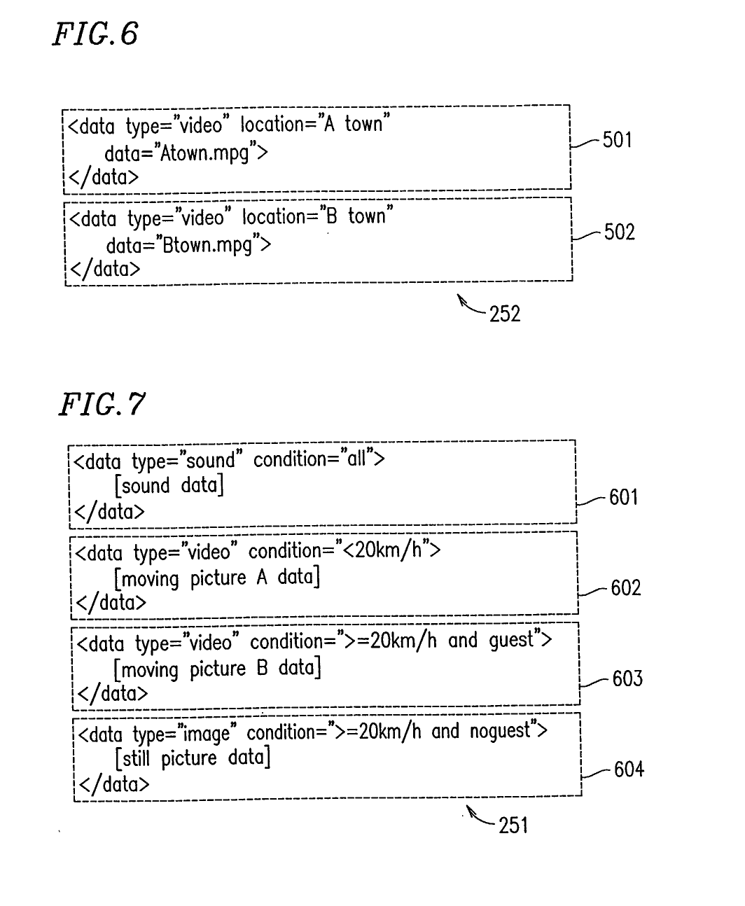

With reference to FIGS. 4 through 7, specific examples of a data structure of the distribution data 251 will be described. FIGS. 4, 5 and 7 each show an example of the distribution data 251 described in the XML format. FIG. 6 shows an example of the attribute data 252 included in the distribution data 251 described in the XML format. The format of describing the distribution data 251 and the attribute data 252 is not limited to the XML format. The distribution data 251 may be described in any format which can be interpreted by the terminal device 100. The XML is a format for describing a structure of a document which has been standardized by the World Wide Web Consortium (W3C). For the World Wide Web Consortium, see, for example, http://www.w3.org. For XML, see, for example, “Hyojun XML Kanzen Kaisetsu” (Complete Guide to the Standard XML) published by Gijutsu Hyoronsha.

As a system for describing a structure of an XML document, the XML Schema has been defined. The XML Schema is described in the above-mentioned web page for W3C, http://www.w3.org.

The distribution data 251 can be described in the MPEG-7 format using the MPEG-7 Description Definition Language which is an expansion of the XML Schema. MPEG-7 has been defined by the International Organization Standardization (ISO) and the International Electrotechnical Commission (IEC) as the standard for keywords used for describing features and elements of multimedia contents, and is described in http://www.cselt.it/mpeg/standards.htm.

In the examples shown in FIGS. 4 through 7, the following terms can be understood to have meanings as follows.

The terms “condition” and “location” are used to specify a condition regarding the state of the terminal device 100.

The term “method” is used to indicate the quality with which the terminal device 100 reproduces content data.

The term “type” is used to specify the kind or sort of the content data (i.e., the type of the media). The “type” can be, for example, “sound”, “video”, “image” or “text”, which respectively indicate that the content data is in the form of sound, a moving picture, a still picture, or text. The terminal device 100 performs reproduction processing suitable to these kinds of content data.

FIG. 4 shows an example of the distribution data 251 described in the XML format.

The distribution data 251 includes parts 351 through 355.

Part 351 indicates that when the state of the terminal device 100 fulfills the condition of “all”, sound data which is defined at the position of “[sound data]” (row 2351) is reproduced. It is determined by the determination section 103 (FIG. 1) whether or not the state of the terminal device 100 fulfills the condition of “all”. In this example, the condition:

condition=“all”

holds true irrespective of the state of the terminal device 100. Accordingly, part 351 indicates that the sound data is always reproduced.

Part 351 does not specify the quality with which the sound data is to be reproduced. When the quality with which the sound data is to be reproduced is not specified, the terminal device 100 reproduces the sound data with the default quality (for example, the highest usable quality).

Part 352 indicates that when the state of the terminal device 100 fulfills the condition of “stop”, data having a label of “videodata” is reproduced with the quality of “all”. The data having the label of “videodata” is defined in part 355 (row 2355).

The condition of “stop” is fulfilled when the terminal device 100 is stationary (i.e., when the movable body 110 having the terminal device 100 mounted thereon is stationary).

The quality of “all” indicates that data is reproduced with the highest usable quality. This means that when the data is moving picture data, data is reproduced without thinning any frame of the moving picture data. In this case, the number of frames per second is, for example, 30.

Part 353 indicates that when the state of the terminal device 100 fulfills the condition of “<20 km/h”, data having the label of “videodata” is reproduced with the quality of “1 frameps”. The data having the label of “videodata” is defined in part 355 (row 2355). As can be appreciated, the moving picture data defined in part 355 is reproduced both when the state of the terminal device 100 fulfills the condition of “stop” and when the state of the terminal device 100 fulfills the condition of “<20 km/h”.

The condition of “<20 km/h” is fulfilled when the moving speed of the terminal device 100 is less than 20 km/h (i.e., when the movable body 110 is moving at a speed of less than 20 km/h).

The quality of “1 frameps” indicates that the moving picture is displayed with the frames of the moving picture data being thinned such that one frame is displayed per second (with the quality being lowered).

Part 354 indicates that when the state of the terminal device 100 fulfills the condition of “>=20 km/h”, image data which is defined at the position of “[still picture data]” (row 2354) is reproduced. The condition of “>=20 km/h” is fulfilled when the moving speed of the terminal device 100 is equal to or greater than 20 km/h (i.e., when the movable body 110 is moving at a speed equal to or greater than 20 km/h).

In the example shown in FIG. 4, when the movable body 110 is stationary, the content is presented in the form of a sound and a moving picture without thinning. When the moving speed of the movable body 110 is less than 20 km/h, the content is presented in the form of a sound and a moving picture with the frames being thinned to one frame per second. When the moving speed of the movable body 110 is equal to or greater than 20 km/h, the content is presented in the form of a sound and a still picture.

The presentation may be set such that when the state of the terminal device 100 is changed while the content is presented, the content is presented in the form which is suitable to the post-change state. Referring to the example shown in FIG. 4, in the case where, for example, the movable body 110 is stationary when the presentation of the content is started, the content is presented in the form of a sound and a moving picture without thinning. It is assumed that the movable body 110 then starts moving and the moving speed of the movable body 110 reaches a speed equal to or greater than 20 km/h. In this case, the content may be presented in the form of a sound and a still picture. In order to realize such processing, the terminal device 100 accumulates the image data defined at the position of the “[still picture]” (row 2354) in a memory (not shown) in the data output section 101 (FIG. 1) of the terminal device 100, upon receiving the distribution data 251.

In the example shown in FIG. 4, row 1351, part 352, part 353 and row 1354 of the distribution data 251 correspond to the attribute data 252. Row 2351, row 2354 and row 2355 correspond to the content data 253.

FIG. 5 shows another example of the distribution data 251 described in the XML format.

In the example shown in FIG. 5, the distribution data 251 includes parts 361 through 363.

Part 361 is identical to part 351 described above with reference to FIG. 4.

Part 362 indicates that when the state of the terminal device 100 fulfills the condition of “<20 km/h”, moving picture data which is defined at the position of “[moving picture data]” is reproduced.

Part 363 indicates that when the state of the terminal device 100 fulfills the condition of “=>20 km/h”, text data which is defined at the position of “[text data]” is reproduced.

In the example shown in FIG. 5, the quality with which data is to be reproduced is omitted.

The ratio of attention paid to a still picture by the driver 111 of the movable body 110, with respect to the entire attention capability of the driver 111, is smaller than the ratio of attention paid to a moving picture. The ratio of attention paid to a moving picture by the driver 111 can be made smaller by lowering the quality with which the moving picture is presented. From the viewpoint of preventing accidents, it is generally preferable to change the kind of picture to be reproduced from a high quality moving picture to a low quality moving picture and further to a still picture, as the state of the movable body 110 changes from being stationary to running at a low speed and further to running at a high speed. It is preferable that such a change in the quality of the picture or the kind of media is specified depending on the content to be distributed.

The quality of picture and the kind of media (i.e., the presentation form of the content) specified by the attribute data 252 may be set to be changeable by the user of the terminal device 100 (for example, the driver 111 of the movable body 110 having the terminal device 100 mounted thereon). For example, in the case where the driver 111 is not very skilled in driving the movable body 110 (for example, an automobile), the terminal device 100 may be set such that an image is not displayed while the movable body 110 is moving, regardless of the moving speed. When the user specifies the presentation form of the content in compliance with such setting, the specification by the user is given priority over the specification of the presentation form of the content made by the attribute data 252.

Such setting can be achieved by providing an interface, through which the user can input data, in the presentation section 104 such that the acquisition section 102 acquires the data inputted by the user as representing the state of the terminal device 100. Alternatively, the above-described setting may be achieved by providing a separate input device in the terminal device 100 such that the acquisition section 102 acquires the data inputted by the user to the separate input device as representing the state of the terminal device 100.

As a condition regarding the state of the terminal device 100, a condition other than the moving speed of the movable body 110 having the terminal device 100 mounted thereon may be specified.

FIG. 6 shows an example of the attribute data 252 described in the XML format. In the example shown in FIG. 6, the position of the terminal device 100 is specified as a condition regarding the state of the terminal device 100.

The attribute data 252 includes parts 501 and 502.

Part 501 indicates that when the state of the terminal device 100 fulfills the condition:

location=“A town”,

data having a label of “Atown.mpg” (for example, a file name) is reproduced. The condition:

location=“A town”

is fulfilled when the position of the terminal device 100 is in town A.

Similarly, part 502 indicates that when the state of the terminal device 100 fulfills the condition:

location=“B town”,

data having a label of “Btown.mpg” (for example, a file name) is reproduced. The condition:

location=“B town”

is fulfilled when the position of the terminal device 100 is in town B. Hereinafter, data having the label “Atown.mpg” will be referred to simply as data “Atown.mpg”, and data having the label “Btown.mpg” will be referred to simply as data “Btown.mpg”.

Data “Atown.mpg” and data “Btown.mpg” may be, for example, moving picture data (content data) representing guide information of town A and town B, respectively. Such content data is not received by the terminal device 100 when the attribute data 252 is received by the terminal device 100, but is received by the terminal device 100 after the attribute data 252 is received. “Atown.mpg” and “Btown.mpg” can be received in one of the following two procedures.

According to one procedure, the terminal device 100 request the service center 201 (FIG. 1) for necessary data among the data “Atown.mpg” and the data “Btown.mpg”. In response to the request, the service center 201 transmits the requested data as the content data 253. In this case, only the data required by the terminal device 100, i.e., the data “Atown.mpg” or the data “Btown.mpg”, is transmitted over the communication path 250 (FIG. 1). This provides an advantage where the transmission band width is saved since only one of data “Atown.mpg” and the data “Btown.mpg” is transmitted. This procedure requires the communication path 250 to be bidirectional.

According to the another procedure, the service center 201 transmits the data “Atown.mpg” and the data “Btown.mpg” as the content data 253 after completely transmitting the attribute data 252. In this case, both the data “Atown.mpg” and the data “Btown.mpg” are transmitted via the communication path 250. The terminal device 100 may accumulate only the data required by the terminal device 100 (e.g., the data “Atown.mpg” when the terminal device 100 is in town A). This procedure is preferably used when the communication path 250 is monodirectional.

As a condition regarding the state of the terminal device 100, a combination of a plurality of conditions may be specified.

FIG. 7 shows still another example of the distribution data 251 described in the XML format. In the example shown in FIG. 7, a combination of (i) the moving speed of the movable body 110 having the terminal device 100 mounted thereon and (ii) whether or not there is a passenger in the movable body 110 is specified as a condition regarding the state of the terminal device 100.

The distribution data 251 includes parts 601 through 604.

Part 601 is identical to part 351 described above with reference to FIG. 4.

Part 602 indicates that when the state of the terminal device 100 fulfills the condition of “<20 km/h”, moving picture data which is defined at the position of “[moving picture A data]” is reproduced.

Part 603 indicates that when the state of the terminal device 100 fulfills the condition of “>=20 km/h and guest”, moving picture data which is defined at the position of “[moving picture B data]” is reproduced. The condition of “>=20 km/h and guest” is fulfilled when the moving speed of the movable body 110 having, the terminal device 100 mounted thereon is equal to or greater than 20 km/h and further there is a passenger in the movable body 110.

Part 604 indicates that when the state of the terminal device 100 fulfills the condition of ”>=20 km/h and noguest”, still picture data which is defined at the position of “[still picture data]” is reproduced. The condition of “>=20 km/h and noguest” is fulfilled when the moving speed of the movable body 110 having the terminal device 100 mounted thereon is equal to or greater than 20 km/h and further there is no passenger in the movable body 110.

The passenger is not engaged in driving the movable body 110. Therefore, it involves no problem in terms of preventing accidents to present a content to the passenger in the form of a moving picture, regardless of the moving speed of the terminal device 100 (i.e., the moving speed of the movable body 110).

Instead of the examples shown in FIGS. 4 through 7, a time or a time zone at which the terminal device 100 presents a content, for example, may be specified as a condition regarding the state of the terminal device 100. In this case, the presentation form of the content can be changed in accordance with the time zone when the content is presented. For example, in the case where the content is an advertisement of a restaurant, the terminal device 100 can present a lunch menu or a dinner menu only in an appropriate time zone.

3. Specific Example 1 of the Content Distribution Service

A specific example of a content distribution service when the state of the terminal device 100 is that there is a passenger in the movable body 110.

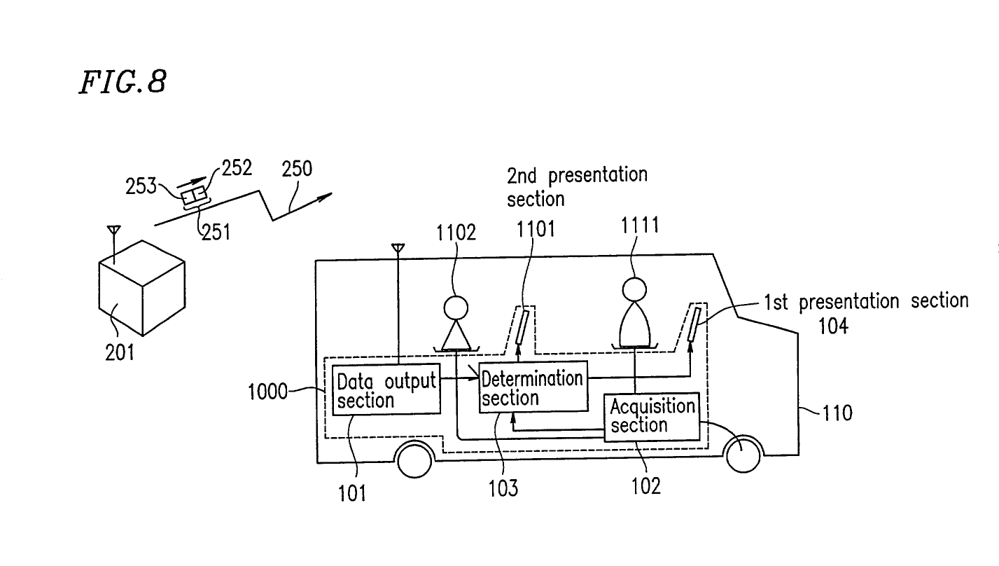

FIG. 8 shows a specific example of a process for providing a content distribution service according to the present invention.

A terminal device 1000, according to the present invention, shown in FIG. 8 includes a first presentation section 104 (corresponding to the presentation section 104 in FIG. 1) and also a second presentation section 1101. Except for this point, the terminal device 1000 in FIG. 8 is identical to the terminal device 1000 in FIG. 1. Identical elements previously discussed with respect to FIG. 1 bear identical reference numerals and the detailed descriptions thereof will be omitted. The number of presentation sections is arbitrary and may exceed two. As shown in FIG. 8, when the movable body 110 is an automobile, the first presentation section 104 is a display on a front seat and the second presentation section 1101 is a display on a rear seat.

In the example shown in FIG. 8, the movable body 110 accommodates an adult passenger 1111 located at the front seat next to the driver's seat (passenger seat) and a child passenger 1102 located at the rear seat as passengers in addition to the driver (not shown). The service center 201 transmits the distribution data 251 including content data which represents information on events (content) of Department Store K. The transmitted distribution data 251 is received by the data output section 101 of the terminal device 1000 mounted on the movable body 110.

The distribution data 251 includes attribute data 252 and content data 253.

The acquisition section 102 acquires the state of the terminal device 1000 that (i) there is at least a passenger in the front seat and the passenger is the adult 1111 and (ii) there is a passenger in the rear seat and the passenger is the child 1102. The state of the terminal device 1000 may be acquired, for example, using a weight sensor provided below each seat or an image sensor provided in the movable body 110, or may be acquired based on the data inputted to a separate input device by the user (e.g., the driver 111 (FIG. 1), the passenger 1102 or the passenger 1111 in the movable body 110 having the terminal device 1000 mounted thereon) as described above. The state of the terminal device 1000 (that the adult passenger 1111 is located in the front seat and the child passenger 1102 is located in the rear seat) is sent to the determination section 103.

The determination section 103 determines whether the state of the terminal device 1000 fulfills the condition included in the attribute data 252. When it is determined that the state fulfills the condition, the content is displayed on the first presentation section 104 and the second presentation section 1101.

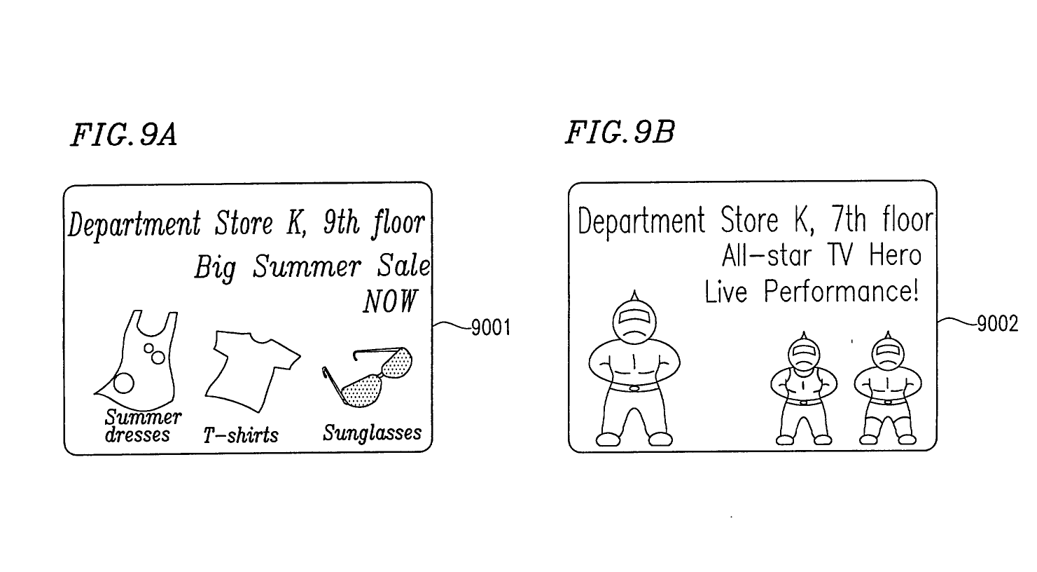

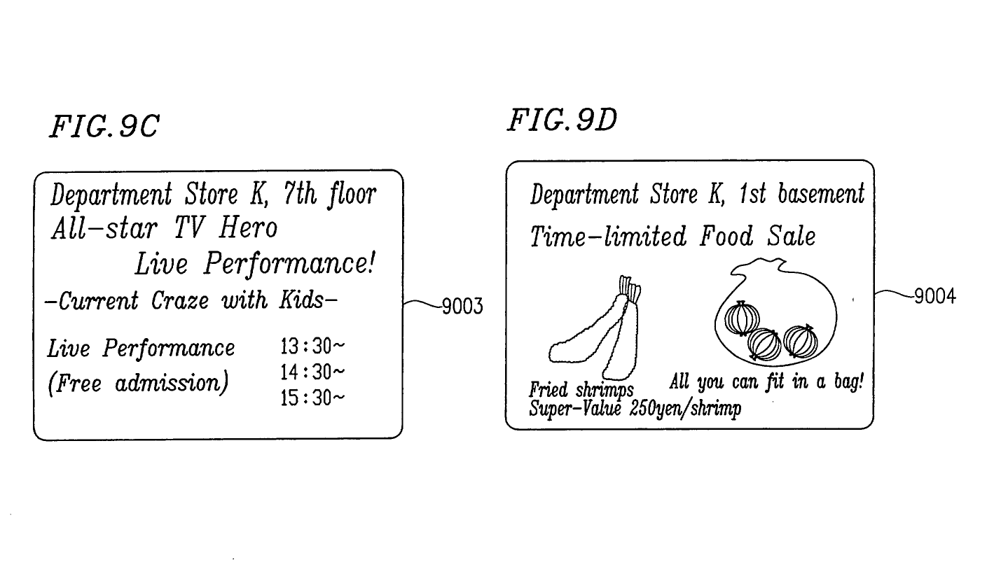

FIG. 9A shows a picture 9001 presented on the first presentation section 104 of the terminal device 1000. The picture 9001 represents information on a big summer sale held on the 9th floor, among the information on events of Department Store K.

FIG. 9B shows a picture 9002 presented on the second presentation section 1101 of the terminal device 1000. The picture 9002 represents information directed to children on an all-star TV hero live performance held on the 7th floor, among the information on events of Department Store K.

FIG. 9C shows another picture 9003 presented on the first presentation section 104 of the terminal device 1000. The picture 9003 represents information directed to adults on the all-star TV hero live performance held on the 7th floor, among the information on events of Department Store K.

FIG. 9D shows still another picture 9004 presented on the first presentation section 104 of the terminal device 1000. The picture 9004 represents information on an time-limited food sale held on the 1st basement, among the information on events of Department Store K.

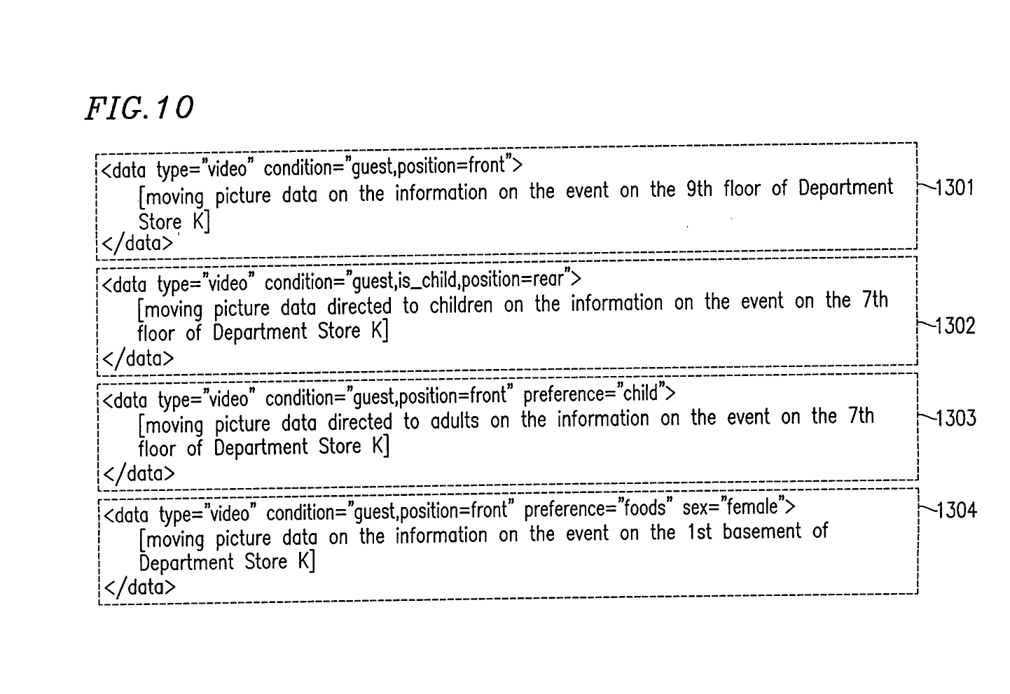

FIG. 10 shows a structure of the distribution data 251 shown in FIG. 8.

The distribution data 251 includes parts 1301 through 1304.

Part 1301 indicates that when the state of the terminal device 1000 fulfills the condition:

condition=“guest,position=front”

(first condition), “[moving picture data on the information on the event on the 9th floor of Department Store K]” is displayed on the first presentation section 104 (first presentation form). The condition:

condition=“guest,position=front”

is fulfilled when the passenger is an adult and located in the front seat. The state of the terminal device 1000 shown in FIG. 8 fulfills this condition.

Part 1302 indicates that when the state of the terminal device 1000 fulfills the condition:

condition=“guest,is_child,position=rear”

(second condition), “[moving picture data directed to children on the information on the event on the 7th floor of Department Store K]” is displayed on the second presentation section 1101 (second presentation form). The condition:

condition=“guest,is_child,position=rear”

is fulfilled when the passenger is a child and located in the rear seat. The state of the terminal device 1000 shown in FIG. 8 fulfills this condition.

Part 1303 indicates that when the state of the terminal device 1000 fulfills the condition:

condition=“guest,position=front” preference=“child”,

“[moving picture data directed to adults on the information on the event on the 7th floor of Department Store K]” is displayed on the first presentation section 104. The condition:

condition=“guest,position=front” preference=“child”

is fulfilled when the passenger is an adult and located in the front seat, and further the preference is a child. The condition that the preference is a child is fulfilled when, for example, the passenger 1111 inputs to the terminal device 1000 in FIG. 8 that information regarding children's entertainment is desired.

Part 1304 indicates that when the state of the terminal device 1000 fulfills the condition: condition=“guest,position=front” preference=“foods” sex=“female”, “[moving picture data on the information on the event on the 1st basement of Department Store K]” is displayed on the first presentation section 104. The condition of: condition=“guest,position=front” preference=“foods” sex=“female” is fulfilled when the passenger is an adult female and located in the front seat, and further the preference is food. The above condition is fulfilled when, for example, the passenger 1111 inputs to the terminal device 1000 in FIG. 8 that the sex of the passenger is female and information on food is desired.

Owing to the above-described structure of the terminal device 1000 and the distribution data 251, the service center 201 can provide content including a plurality of types of information on Department Store K to a plurality of presentation sections (e.g., the first presentation section 104 and the second presentation section 1101) of one movable body 110. Each of the plurality of types of information is provided in the presentation form (FIGS. 9A through 9D) selected in accordance with the position of a passenger and/or profile of a passenger. The position of a passenger is selected from the group consisting of front seat, front and rear seats, and rear seat. The profile of a passenger is at least one selected from the group consisting of sex, adult or child, age, interest, and preference.

In the examples described above with reference to FIGS. 8 through 10, the attribute data specifies, in advance, the position of a passenger (i.e., the site at which the content is to be presented) as a condition regarding the state of the terminal device 1000, and the content is presented to at least one of the first presentation section 104 or the second presentation section 1101 based on the specification of the site. The present invention is applicable to the case where attribute data does not specify the position of a passenger as a condition regarding the state of a terminal device.

In the following example, the movable body 110 having the terminal device 1000 mounted thereon accommodates a passenger, and a content is presented to at least one of the first presentation section 104 or the second presentation section 1101 without the attribute data specifying the position of the passenger as a condition regarding the state of the terminal device 1000.

In this case, the acquisition section 102 acquires the state of the terminal device 1000 that the movable body 110 having the terminal device 1000 mounted thereon accommodates an adult passenger 1111 and a child passenger 1102 (FIG. 8). The acquisition section 102 further acquires presentation site specification information which specifies at least one of the first presentation section 104 or the second presentation section 1101 as the presentation site. The presentation site specification information is associated with the state acquired by the acquisition section 102. In the example shown in FIG. 8, the presentation site specification information includes (i) the information that an adult passenger 1111 is located in the front seat (i.e., that the content should be presented to the first presentation section 104 in the presentation form corresponding to the state of the terminal device 1000 where there is an adult passenger 1111) and (ii) the information that a child passenger 1102 is located in the rear seat (i.e., that content should be presented to the second presentation section 1101 in the presentation form corresponding to the state of the terminal device 1000 that there is a child passenger 1102). The presentation site specification information can be acquired by, for example, providing a weight sensor, an infrared sensor, an image sensor or the like at the seats in the movable body 110. The state and the presentation site specification information acquired by the acquisition section 102 are sent to the determination section 103.

The determination section 103 determines whether the state of the terminal device 1000 fulfills a condition included in the attribute data 252 as described above. When it is determined that the state fulfills the condition, the content is presented to at least one of the first presentation section 104 or the second presentation section 1101 specified by the presentation site specification information which is associated with the state fulfilling the condition.

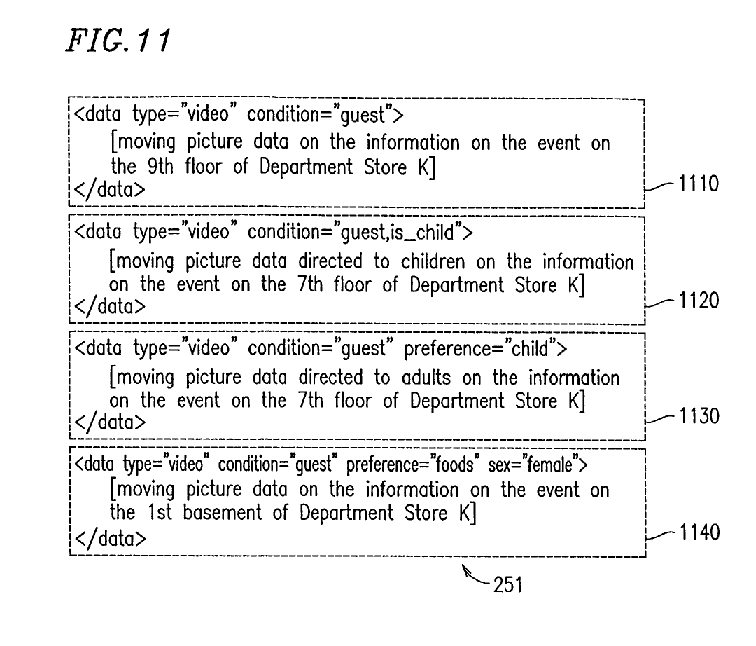

FIG. 11 shows another structure of the distribution data 251 shown in FIG. 8.

In the example shown in FIG. 11, the distribution data 251 includes parts 1110, 1120, 1130 and 1140.

Part 1110 is identical to part 1301 in FIG. 10 except that part 1110 does not include the condition regarding the position of the passenger. When the state of the terminal device 1000 fulfills the condition of: condition=“guest” (i.e., there is an adult passenger 1111) and this state is associated with the presentation site specification information that the adult passenger 1111 is located in the front seat, “[moving picture data on the information on the event on the 9th floor of Department Store K]” is displayed on the first presentation section 104. Namely, the picture 9001 in FIG. 9A is displayed on the first presentation section 104.

Part 1120 is identical to part 1302 in FIG. 10 except that part 1120 does not include the condition regarding the position of the passenger. When the state of the terminal device 1000 fulfills the condition:

condition=“guest,is child”

(i.e., there is a child passenger 1102) and this state is associated with the presentation site specification information that the child passenger 1102 is located in the rear seat, “[moving picture data directed to children on the information on the event on the 7th floor of Department Store K]” is displayed on the second presentation section 1101. Namely, the picture 9002 in FIG. 9B is displayed on the second presentation section 1101.

Part 1130 is identical to part 1303 in FIG. 10 except that part 1130 does not include the condition regarding the position of the passenger. When the state of the terminal device 1000 fulfills the condition:

condition=“guest” preference=“child”

(i.e., there is an adult passenger 1111 and the preference is a child) and this state is associated with the presentation site specification information that the adult passenger 1111 is located in the front seat, “[moving picture data directed to adults on the information on the event on the 7th floor of Department Store K]” is displayed on the first presentation section 104. Namely, the picture 9003 in FIG. 9C is displayed on the first presentation section 104.

Part 1140 is identical to part 1304 in FIG. 10 except that part 1140 does not include the condition regarding the position of the passenger. When the state of the terminal device 1000 fulfills the condition:

condition=“guest” preference=“foods” sex=“female”

(i.e., there is an adult female passenger 1111 and the preference is food) and this state is associated with the presentation site specification information that the adult female passenger 1111 is located in the front seat, “[moving picture data on the information on the event on the 1st basement of Department Store K]” is displayed on the first presentation section 104. Namely, the picture 9004 in FIG. 9D is displayed on the first presentation section 104.

The distribution data 251 shown in FIGS. 10 and 11 is merely illustrative. The distribution data 251 may be arbitrarily structured in accordance with the intention of the transmitting party 211 (FIG. 1).

The terminal device 1000 determines on which presentation section (the first presentation section 104 or the second presentation section 1101) the content is to be presented. Therefore, the attribute data need not specify the position of the passenger (i.e., the presentation site of the content) as a condition regarding the state of the terminal device 100. The transmitting party 211 need not prepare the presentation form of the content in accordance with the position of the passenger. Thus, the band width for transmission can be saved.

4. Specific Example 2 of the Content Distribution Service

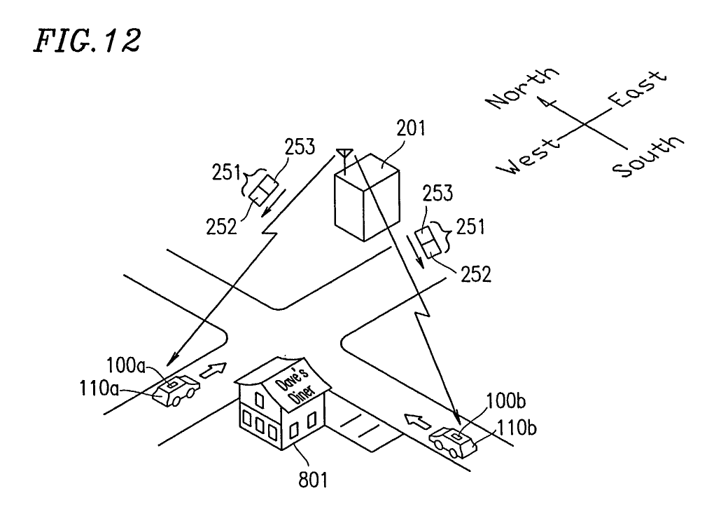

FIG. 12 shows a specific example of a process for providing a content distribution service according to the present invention.

The service center 201 transmits (broadcasts) distribution data 251 including content data representing an advertisement of a restaurant 801 (content). The distribution data 251 is received by a terminal device 100a mounted on a movable body 110a and by a terminal device 100b mounted on a movable body 110b. The terminal devices 100a and 100b may each have substantially the same structure as that of the terminal device 100 described above with reference to FIG. 1.

The movable body 110a is moving east, and the movable body 110b is moving north.

The distribution data 251 includes attribute data 252 and content data 253.

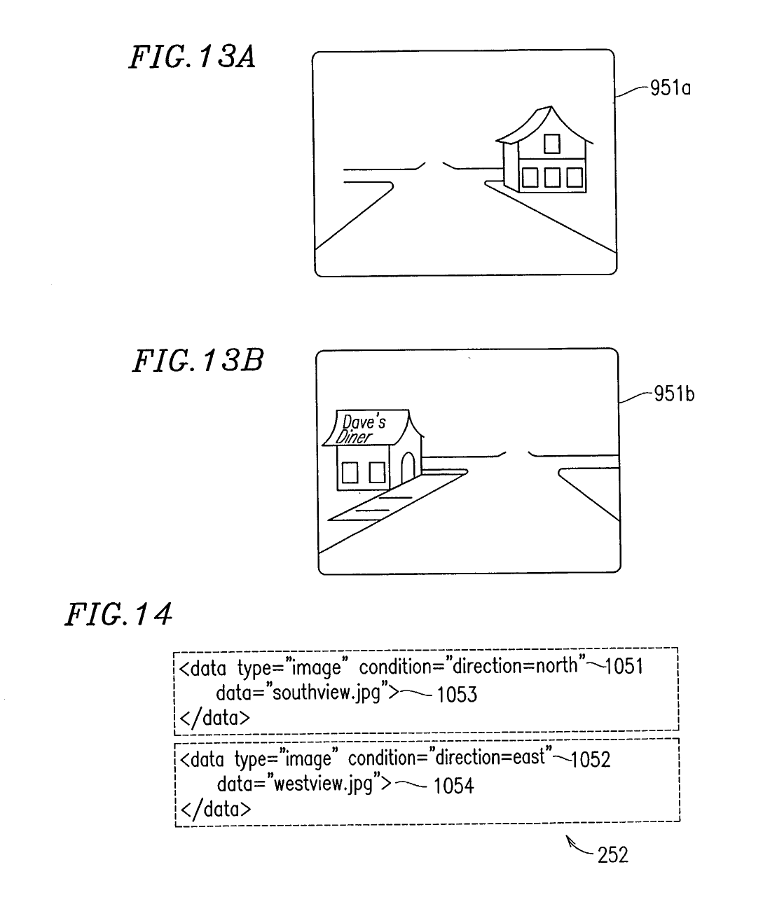

FIG. 13A shows a still picture 951a presented on the presentation section 104 (not shown in FIG. 12; see FIG. 1) of the terminal device 100a. The still picture 951a represents the restaurant 801 seen from the west.

FIG. 13B shows a still picture 951b presented on the presentation section 104 (not shown in FIG. 12; see FIG. 1) of the terminal device 100b. The still picture 951b represents the restaurant 801 seen from the south.

FIG. 14 shows a structure of the attribute data 252 shown in FIG. 12.

The condition “direction=north” in row 1051 is fulfilled when the terminal device is moving north. The terminal device 100b in FIG. 12 fulfills this condition.

The condition “direction=east” in row 1052 is fulfilled when the terminal device is moving east. The terminal device 100a in FIG. 12 fulfills this condition.

Data “southview.jpg” in row 1053 represents the still picture 951b (FIG. 13B). The format of the data “southview.jpg” is, for example, JPEG.

Data “westview.jpg” in row 1054 represents the still picture 951a (FIG. 13A). The format of the data “westview.jpg” is, for example, JPEG.

The data “westview.jpg” and the data “southview.jpg” are transmitted (broadcasted) to the terminal devices 100a and 100b as the content data 253. Among the content data 253 received, the terminal device 100a accumulates and displays only the data “westview.jpg” as necessary data. Among the content data 253 received, the terminal device 100b accumulates and displays only the data “southview.jpg” as necessary data.

In FIG. 14, the rows 1051 through 1054 correspond to the attribute data which specifies the conditions regarding the state of the terminal devices 100a and 100b and the presentation forms of the content (advertisement) corresponding to the conditions. The data “westview.jpg” and the data “southview.jpg” correspond to the content data which represents the content.

Owing to such a structure of the distribution data 251, the service center 201 (FIG. 12) can provide an advertisement of the restaurant 801 in different presentation forms (the form shown in FIG. 13A and the form shown in FIG. 13B) to the driver of the movable body 110a and the driver of the movable body 110b. Such presentation forms are very preferable for the drivers to easily identify the restaurant 801 while driving. The reason for this is because the external appearance of the restaurant 801 is shown to the drivers of the movable bodies 110a and 110b exactly as the driver see the restaurant 801 in the outside scenery.

In this example, images of the restaurant 801 seen from different directions are presented to the terminal devices 100a and 100b based on the moving directions thereof. Instead, the images of the restaurant 801 seen from different directions may be presented to the terminal devices 100a and 100b based on the positions thereof. For example, to the terminal device located to the west of the restaurant 801 (in the example shown in FIG. 12, the terminal device 100a), an image of the restaurant 801 seen from the west maybe presented. To the terminal device located to the south of the restaurant 801 (in the example shown in FIG. 12, the terminal device 100b), an image of the restaurant 801 seen from the south may be presented.

The example illustrated with reference to FIGS. 12, 13A, 13B and 14 show that it is preferable to make the attribute data 252 reliant on the content (in this example, the advertisement) by creating the attribute data 252 in accordance with the intention of the transmitting party 211 (FIG. 1).

In the exemplary content distribution services described above with reference to FIGS. 1 through 14, the content data representing a content is distributed from the service center 201 (FIG. 1) managed by the transmitting party 211 (FIG. 1). The present invention is not limited to broadcasting the content data via the communication path 250 (FIG. 1). For example, content data and attribute data reflecting the intention of a transmitting party may be recorded in advance on an information recording medium. The information recording medium may be, for example, an optical disc, a magnetic disc or the like. In the case where the content data and the attribute data are recorded on an information recording medium in advance, the data output section 101 of the terminal device 100 (FIG. 1) and the terminal device 1000 (FIG. 8) acts to output the reproduced content data and attribute data to the determination section 102. In this case, the element other than the data output section 101 are the same as those shown in FIG. 1.

In the above examples, the terminal device 100 (or 1000, 100a, 100b) is mounted on the movable body 110 (or 110a, 100b). This is only for the purpose of illustrating an example in which the state of the terminal device 100 can be changed. The present invention is not to be interpreted to be limited to the case where a terminal device is mounted on a movable body. The principle of the present invention is applicable to any terminal device including a detection section or an acquisition section for detecting a state of the terminal device.

According to the present invention, a content distribution service for visually handicapped people and/or auditorily handicapped people can be easily implemented. For example, as the acquisition section 102 (FIG. 1), any device, which is usable for inputting whether the user of the terminal device 100 is visually handicapped or auditorily handicapped as the state of the terminal device 100, is used. Then, verbal commentary for the auditorily handicapped people or subtitles for visually handicapped people can be presented to the presentation section 104.

According to the present invention, data representing a prescribed content and attribute data are transmitted to a terminal device. The attribute data specifies a condition regarding the state of the terminal device and the presentation form of the content corresponding to the condition. By structuring the attribute data in compliance with the intention of the provider of the content distribution service (transmitting party of the content), the terminal device can reflect the intention of the transmitting party in the presentation form of the content in accordance with the state of the terminal device.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A process for providing a content distribution service using a terminal device including an acquisition section for acquiring a state of the terminal device and a processing device for transmitting data to the terminal device, the process comprising the steps of:
the processing device acquiring content data representing a prescribed content;
the processing device acquiring attribute data which specifies a condition regarding the state of the terminal device and a presentation form of the content corresponding to the condition; and
the processing device transmitting the content data and the attribute data to the terminal device.

2. A process according to claim 1, wherein the step of transmitting the content data and the attribute data includes the step of transmitting the content data and the attribute data as one packet.

3. A process according to claim 1, wherein the attribute data specifies, as the condition regarding the state of the terminal device, at least one of a condition regarding a position of the terminal device, a condition regarding a time when the terminal device presents the content, a condition regarding a time zone in which the terminal device presents the content, a condition regarding whether or not there is a passenger in a movable body having the terminal device mounted thereon, a condition regarding a moving speed of the movable body, and a condition regarding a time period in which the moving speed is continuously equal to or lower than a prescribed value.

4. A process according to claim 3, wherein:
when there is a passenger in the movable body, the attribute data further specifies at least one of a condition regarding a position of the passenger and a condition regarding a profile of the passenger,
the condition regarding the position of the passenger is selected from the group consisting of front seat, rear seat, and front and rear seats,
the condition regarding the profile of the passenger is at least one selected from the group consisting of sex, adult or child, age, interest, and preference.

5. A process according to claim 4, wherein the attribute data specifies the presentation form of the content which changes in accordance with at least one of the position of the passenger and the profile of the passenger.

6. A process according to claim 1, wherein the presentation form includes at least one of a form of presenting the content as a moving picture, a form of presenting the content as a still picture, and a form of presenting the content as a sound.

7. A process according to claim 1, wherein the presentation form includes a form of presenting the content as a moving picture, and the attribute data specifies a number of frames per second of the moving picture.

8. A process according to claim 1, wherein the presentation form includes a form of presenting the content as a sound, and the attribute data specifies a number of reproduction channels of the sound.

9. A terminal device, comprising:
a data output section for outputting content data representing a prescribed content, and attribute data which specifies a condition regarding a state of the terminal device and a presentation form of the content corresponding to the condition;
an acquisition section for acquiring the state of the terminal device;
a determination section for determining whether or not the state acquired by the acquisition section fulfills the condition; and
at least one presentation section for, when the state acquired by the acquisition section is determined to fulfill the condition, presenting the content in a presentation form of the content corresponding to the condition.

10. A terminal device according to claim 9, wherein the data output section receives the content data and the attribute data from outside the terminal device, and outputs the content data and the attribute data to the determination section.

11. A terminal device according to claim 9, wherein the data output section reproduces the content data and the attribute data stored on an information recording medium and outputs the reproduced content data and attribute data to the determination section.

12. A terminal device according to claim 9, wherein:
the terminal device includes a first presentation section and a second presentation section,
the attribute data specifies at least either a first condition regarding the state of the terminal device and a first presentation form of the content corresponding to the first condition, or a second condition regarding the state of the terminal device and a second presentation form of the content corresponding to the second condition,
the determination section determines whether the state acquired by the acquisition section fulfills the first condition or the second condition,
when the determination section determines that the state acquired by the acquisition section fulfills the first condition, the first presentation section presents the content in the first presentation form, and
when the determination section determines that the state acquired by the acquisition section fulfills the second condition, the second presentation section presents the content in the second presentation form.

13. A terminal device according to claim 9, wherein:
the terminal device includes a first presentation section and a second presentation section,
the acquisition section further acquires presentation site specification information which is associated with the state acquired by the acquisition section and specifies at least one of the first presentation section and the second presentation section as a presentation site of the content, and
when the determination section determines that the state acquired by the acquisition section fulfills the condition, at least one of the first presentation section and the second presentation section which is specified by the presentation site specification information presents the content.

14. A terminal device according to claim 9, wherein the attribute data specifies, as the condition regarding the state of the terminal device, at least one of a condition regarding a position of the terminal device, a condition regarding a time when the terminal device presents the content, a condition regarding a time zone in which the terminal device presents the content, a condition regarding whether or not there is a passenger in a movable body having the terminal device mounted thereon, a condition regarding a moving speed of the movable body, and a condition regarding a time period in which the moving speed is continuously equal to or lower than a prescribed value.

15. A terminal device according to claim 14, wherein:
when there is a passenger in the movable body, the attribute data further specifies at least one of a condition regarding a position of the passenger and a condition regarding a profile of the passenger,
the condition regarding the position of the passenger is selected from the group consisting of front seat, rear seat, and front and rear seats, and
the condition regarding the profile of the passenger is at least one selected from the group consisting of sex, adult or child, age, interest, and preference.

16. A terminal device according to claim 15, wherein the attribute data specifies the presentation form of the content which changes in accordance with at least one of the position of the passenger and the profile of the passenger.

17. A terminal device according to claim 9, wherein the presentation form includes at least one of a form of presenting the content as a moving picture, a form of presenting the content as a still picture, and a form of presenting the content as a sound.

18. A terminal device according to claim 9, wherein the presentation form includes a form of presenting the content as a moving picture, and the attribute data specifies a number of frames per second of the moving picture.

19. A terminal device according to claim 9, wherein the presentation form includes a form of presenting the content as a sound, and the attribute data specifies a number of reproduction channels of the sound.
